(19) United States
(12) Patent Application Publication
(10) Pub. No.: US 2026/0309915 A1
(43) Pub. Date: Oct. 8, 2026

(54) DISTRIBUTED BRAGG GRATING WITH ULTRALOW INDEX PERTURBATION

(71) Applicant: University of Rochester, Rochester, NY (US)

(72) Inventors: Qiang Lin, Rochester, NY (US); Shixin Xue, Rochester, NY (US)

(73) Assignee: University of Rochester, Rochester, NY (US)

(21) Appl. No.: 19/482,221

(22) PCT Filed: May 7, 2024
(86) PCT No.: PCT/US2024/028156

§ 371 Date: Nov. 6, 2025

Related U.S. Application Data
(60) Provisional application No. 63/464,688, filed on May 8, 2023.

(51) Int. Cl. G02B 6/122; G02B 6/12; G02B 6/136

(52) U.S. Cl. CPC G02B 6/1223; G02B 6/136; G02B 2006/1204; G02B 2006/12045; G02B 2006/12061; G02B 2006/12097; G02B 2006/12107; G02B 2006/12176

(57) ABSTRACT

A waveguide grating with an ultralow index perturbation is described. A waveguide structure comprises a core and a cladding. The cladding is made of a material that has a lower refractive index than a material of the core. The waveguide grating is formed in the material of the cladding, and the waveguide grating does not extend into the waveguide core.

### CROSS-REFERENCE TO RELATED APPLICATIONS

This application claims priority to U.S. Provisional Patent Application No. 63/464,688, filed on May 8, 2023, the disclosure of which is incorporated by reference in its entirety for all purposes.

### STATEMENT REGARDING FEDERALLY SPONSORED RESEARCH OR DEVELOPMENT

This invention was made with government support under Contract HR001-20-2-0044, awarded by the Defense Advanced Research Projects Agency. The government has certain rights in the invention.

### BACKGROUND

The present disclosure relates to photonic systems, and without limitation to a reflective grating in a chip. Integrated lasers have revolutionized various fields. The technology has been developed prosperously during the last few decades. The density of the photonic integrated circuit (PIC) keeps increasing, and integration methods are evolving from hybrid integration to heterogenous integration to monolithic integration. Applications of integrated lasers range from telecommunications and data processing to imaging, sensing, and bio photonics. The integration of lasers onto compact semiconductor platforms has paved the way for the miniaturization of photonic devices, leading to higher efficiency and reliability, along with reduced cost and energy consumption.

A Distributed Bragg Reflector (DBR) Laser is a semiconductor laser containing one or more Bragg reflectors or gratings and has many applications, such as in optical phased arrays (OPAs) and narrow-linewidth diode lasers.

### BRIEF SUMMARY

In some configurations, a system for a waveguide structure comprises a waveguide core formed in a device layer of a semiconductor structure or a dielectric structure; a waveguide cladding, wherein the waveguide cladding is made of a material that has a lower refractive index than a material of the waveguide core; and/or a grating formed in the material of the waveguide cladding. The grating formed in the waveguide cladding does not extend into the waveguide core, the grating is a Bragg grating, the Bragg grating has a periodic refractive index modulation between a high refractive index and a low refractive index, the high refractive index is the material of the waveguide cladding, and/or the waveguide structure is part of a photonic integrated chip. The waveguide core comprises lithium niobate, lithium tantalate, silicon, silicon nitride, or a III-V semiconductor compound, in some embodiments.

In some configurations, a system for waveguide structure comprises a waveguide core; a waveguide cladding, wherein the waveguide cladding is made of a material that has a lower refractive index than a material of the waveguide core; and/or a grating formed in the material of the waveguide cladding, wherein the grating formed in the waveguide cladding does not extend into the waveguide core. In some embodiments, the waveguide core is formed in a device layer of a semiconductor structure; the waveguide structure is part of a photonic integrated chip; the grating is a Bragg grating; the grating has a periodic refractive index modulation between a high refractive index and a low refractive index; the high refractive index is the material of the waveguide cladding; the waveguide core comprises single-crystal silicon or III-V compound; the waveguide cladding comprises a silicon oxide; the waveguide core comprises lithium niobate, lithium tantalate, or silicon nitride; and/or the waveguide core is a rib waveguide.

In some configurations, a method for making for a waveguide structure comprises forming a waveguide core; applying a waveguide cladding on the waveguide core, wherein the waveguide cladding is made of a material that has a lower refractive index than a material of the waveguide core; and/or forming a grating in the material of the waveguide cladding, after applying the waveguide cladding on the waveguide core, wherein the grating formed the waveguide cladding does not extend into the waveguide core. In some embodiments, the method further comprises etching the waveguide cladding to from the grating; depositing material on the waveguide cladding to form the grating; and/or comprising forming electrical devices in the device layer of the semiconductor structure. In some embodiments, the waveguide core is formed in a device layer of a semiconductor structure; the waveguide structure is part of a photonic integrated chip; the grating is a Bragg grating; the grating has a periodic refractive index modulation between a high refractive index and a low refractive index; the high refractive index is the material of the waveguide cladding; the waveguide core comprises single-crystal silicon or a III-V compound; the waveguide cladding comprises a silicon oxide; and/or the waveguide core comprises lithium niobate, lithium tantalate, or silicon nitride.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIG. 1 is a perspective view of an embodiment of a waveguide structure with a grating formed in the cladding of the waveguide structure.

FIG. 2A illustrates a side view of an embodiment of a waveguide structure with a grating formed in the cladding of the waveguide structure using protrusions.

FIG. 2B illustrates a front view of the embodiment of the waveguide structure in FIG. 2A.

FIG. 3A illustrates a side view of an embodiment of a waveguide structure with a grating formed in the cladding of the waveguide structure using etching.

FIG. 3B illustrates a front view of the embodiment of the waveguide structure in FIG. 3A.

FIG. 4A illustrates a side view of an embodiment of a waveguide structure with a core formed by deposition and a grating formed in the cladding of the waveguide structure using protrusions.

FIG. 4B illustrates a front view of the embodiment of the waveguide structure in FIG. 4A.

FIG. 5A illustrates a side view of an embodiment of a waveguide structure with a core formed by deposition and a grating formed in the cladding of the waveguide structure using etching.

FIG. 5B illustrates a front view of the embodiment of the waveguide structure in FIG. 5A.

FIG. 6 is a chart of a simulated reflection spectrum for an embodiment of a designed DBR grating structure for a thin-film lithium niobate waveguide.

FIG. 7 is a chart of a recoded transmission spectrum of an embodiment of a designed DBR grating structure for a thin-film lithium niobate waveguide.

FIG. 8 is a flowchart of an embodiment of a process for fabricating a waveguide structure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

The present disclosure relates to a photonic system, and more particularly and without limitation relates to a new distributed Bragg grating with ultralow index perturbation. In accordance with one or more illustrative embodiments of the present disclosure, a distributed Bragg reflector (DBR) having a novel grating structure that is able to achieve weak index perturbation is disclosed.

In some applications for a Distributed Bragg Reflector (DBR), a weak index perturbation, i.e., a low grating coupling strength-low K, is used to achieve small beam divergence in an Optical Phased Arrays (OPA) and/or to achieve narrow laser linewidth in a distributed Bragg reflector (DBR) diode laser. In the past two decades, significant efforts have been devoted to developing a variety of types of DBR grating structures. Unfortunately, achieving a very low K and a low propagation loss turns out to be challenging, particularly for high-index optical waveguide media such as silicon, III-V, etc. An approach to realize ultralow K in a controllable way while reducing or minimizing an introduction of extra propagation loss can be desirable in some applications for broad integrated photonics in integrated lasers and/or chip-scale OPAs.

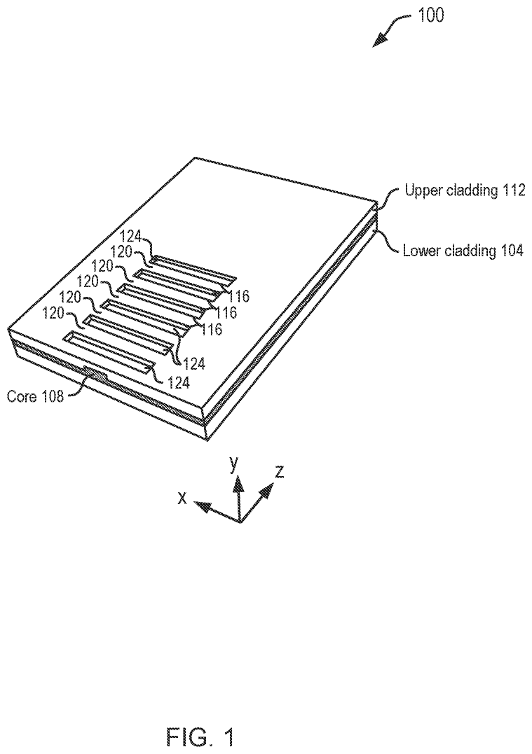

Referring to FIG. 1, a perspective view of an embodiment of a waveguide structure 100 is shown. The waveguide structure comprises a lower cladding 104, a core 108, and an upper cladding 112. The core 108 is between the lower cladding 104 and the upper cladding 112. Material used for the lower cladding 104, and/or material used for the upper cladding 112, has a lower refractive index than material used for the core 108, so that light is at least partially confined to propagate within the core 108. In some situations, the core 108 is referred to as a waveguide core. Some skilled in the art might refer to the core 108 as simply a waveguide. In some situations, the cladding (e.g., lower cladding 104 and/or the upper cladding 112) is referred to as a waveguide cladding.

Walls 116 formed in the upper cladding 112 (e.g., by etching or deposition) define ridges 120 (or teeth) and/or trenches 124 in the upper cladding 112, which define a grating formed in the cladding. The walls 116 of the grating do not extend into the core 108, so that the grating formed in the cladding does not extend into the core 108 of the waveguide structure.

In some configurations, the core 108 is formed in a device layer of a semiconductor structure. For example, the core 108 is made from a device layer (e.g., single-crystal silicon) of a silicon-on-insulator wafer; the lower cladding 104 is made from a buried-oxide layer (BOX) of the SOI wafer; the lower cladding 104 is on a silicon substrate; and/or the upper cladding 112 is a silicon oxide (e.g., silicon dioxide) disposed on the core 108 and/or the lower cladding 104 after the device layer is etched to form a ridge waveguide in the device layer of the SOI wafer. A person skilled in the art will recognize many variations (e.g., using other semiconductor materials such as GaAs, InP, using glass or polymer substrates, using a dielectric for the core 108 such as lithium niobate, lithium tantalate, or silicon nitride, etc.).

In some configurations, the waveguide structure is part of a photonic integrated chip (e.g., a chip comprising optical and/or electrical components). For example, a laser and/or OPA is integrated on a common substrate (e.g., a substrate made from a handle portion of the SOI wafer used to make the waveguide structure 100) as the waveguide structure 100. The upper cladding 112 is arranged so that the core 108 is between the upper cladding 112 and a substrate.

The grating in the upper cladding 112 of the waveguide structure 100 is a Bragg grating. The grating has a periodic refractive index modulation between a high refractive index (e.g., the index of the upper cladding 112) and a low refractive index (e.g., the index of air or a covering over the upper cladding 112).

Unlike some Bragg gratings that are defined in the core 108, the grating in the waveguide structure 100 is defined in the upper cladding 112 and not the core 108. Etching quality of the grating can be well controlled to be very high, resulting in low to negligible propagation loss. The grating is not limited to waveguide geometry, structure, or material. The embodiment shown in FIG. 1 uses a rib waveguide for core 108, but other waveguide shapes can be used. Since no grating structure is etched into the core 108, the optical waveguide itself remains high optical quality.

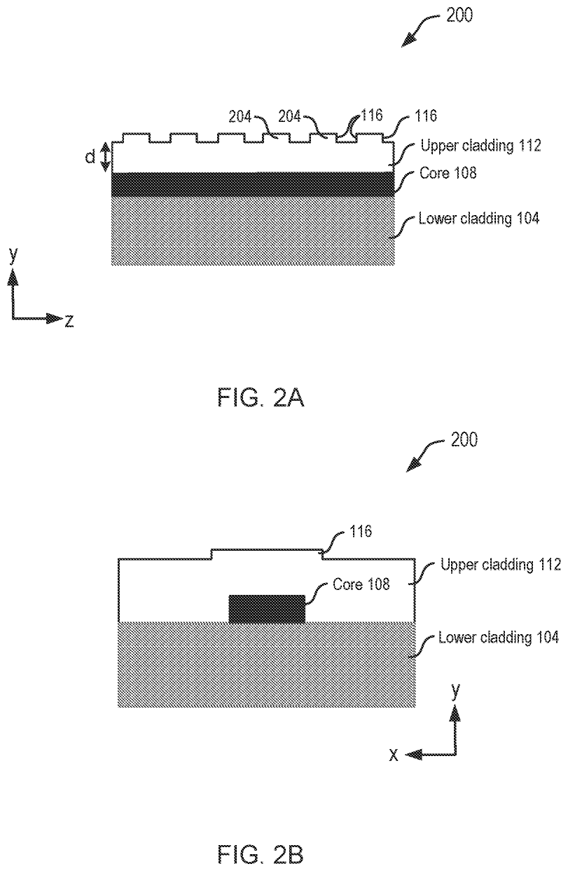

FIG. 2A illustrates a side view of an embodiment of a waveguide structure 200 with a grating formed in the upper cladding 112 of the waveguide structure 200 using protrusions 204. Protrusions 204 are added to the upper cladding 112 (e.g., by deposition) and become part of the upper cladding 112. Though the embodiment shown in FIGS. 2A and 2B use the same material for the protrusions 204 as the upper cladding 112 (e.g., silicon dioxide), the protrusions can be of different material in some embodiments. The protrusions 204 are defined by walls 116 and are ridges, or teeth, of a grating.

The grating coupling strength K can not only be controlled by the defined the grating structure itself (e.g., heights of walls 116, grating period, duty cycle, etc.), it can also be controlled by the layer thickness d of the upper cladding 112 to engineer overlap with an optical guided mode, leading to flexible control of the k value.

FIG. 2B illustrates a front view of the embodiment of the waveguide structure in FIG. 2A. The core 108 is a ridge waveguide.

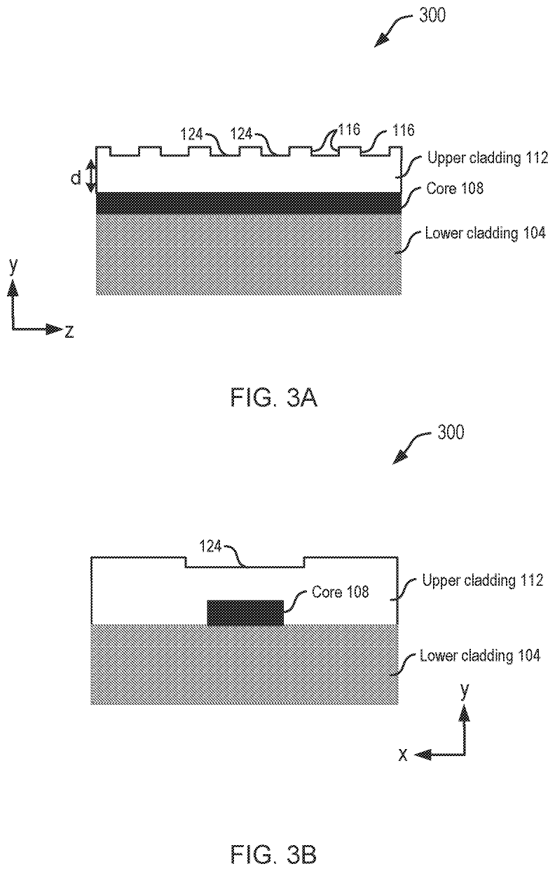

FIG. 3A illustrates a side view of an embodiment of a waveguide structure 300 with a grating formed in the upper cladding 112 of the waveguide structure 300 using etching to form trenches 124.

FIG. 3B illustrates a front view of the embodiment of the waveguide structure in FIG. 3A. The core 108 of the waveguide structure 300 is a ridge waveguide.

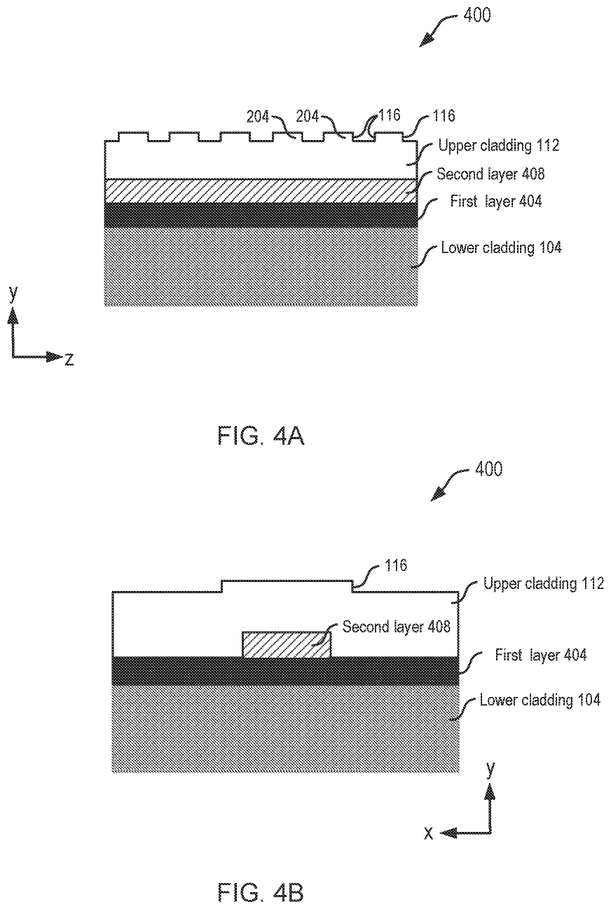

FIG. 4A illustrates a side view of an embodiment of a waveguide structure 400 with a core 108 formed by deposition and a grating formed in the cladding of the waveguide structure 400 using protrusions 204. FIG. 4A illustrates an embodiment similar to the embodiment of FIG. 2A except the core 108 is a rib waveguide comprising a first layer 404 and a second layer 408 (e.g., the material of the second layer 408 is lithium niobate deposited on the first layer 404, which is single-crystal silicon).

FIG. 4B illustrates a front view of the embodiment of the waveguide structure 400 in FIG. 4A.

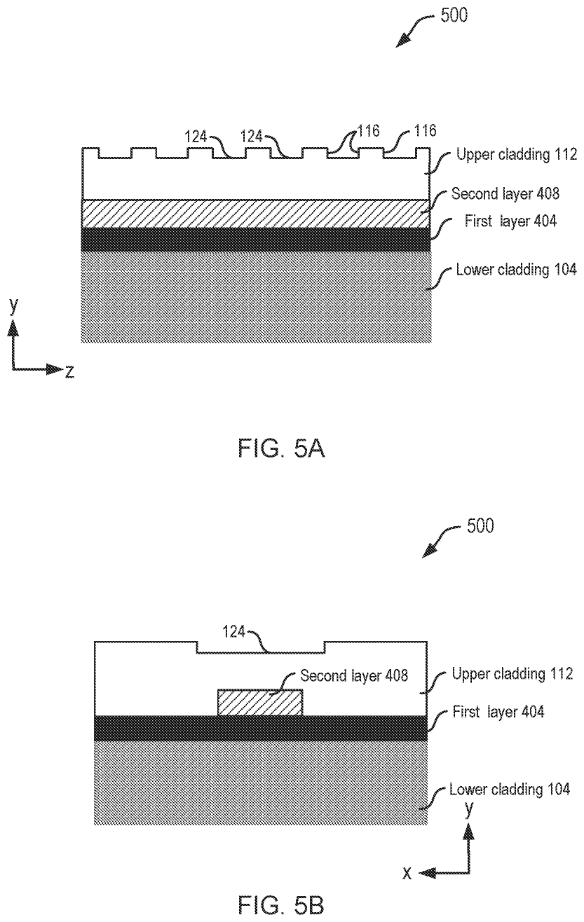

FIG. 5A illustrates a side view of an embodiment of a waveguide structure 500 with a core 108 formed by deposition and a grating formed in the cladding of the waveguide structure using etching to form trenches 124. FIG. 5A illustrates an embodiment similar to the embodiment of FIG. 3A except the core 108 is a rib waveguide comprising a first layer 404 and a second layer 408 (e.g., the material of the second layer 408 is lithium niobate deposited on the first layer 404, which is single-crystal silicon).

FIG. 5B illustrates a front view of the embodiment of the waveguide structure in FIG. 5A.

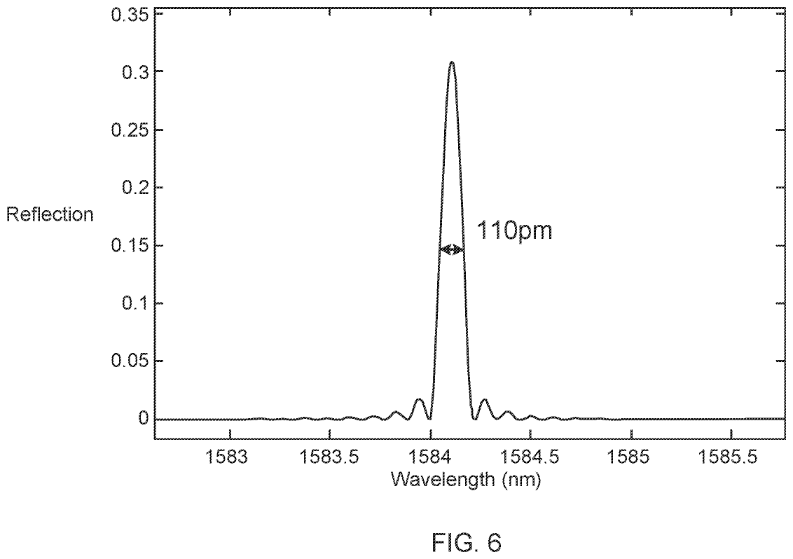

FIG. 6 is a chart of a simulated reflection spectrum for an embodiment of a designed DBR grating structure for a thin-film lithium niobate waveguide. The ultralow-k of the grating structure results in a narrow bandwidth of about 110 pm on the reflection spectrum.

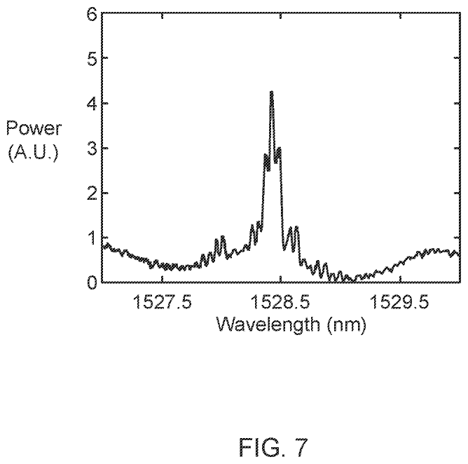

FIG. 7 is a chart of a recoded transmission spectrum of an embodiment of a designed DBR grating structure for a thin-film lithium niobate waveguide. FIG. 7 verifies the narrow spectral width.

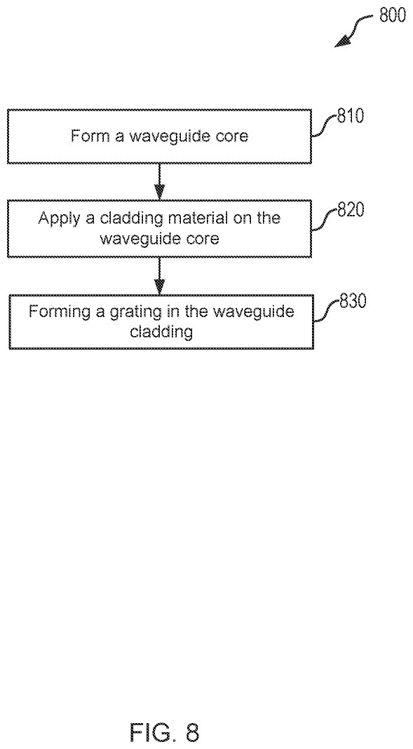

FIG. 8 is a flowchart of an embodiment of a process 800 for fabricating a waveguide structure for a photonic integrated circuit. Process 800 begins in step 810 with forming a waveguide core. For example, a device layer is an SOI wafer is etched to form a ridge waveguide (e.g., see core 108 in FIG. 2B).

In step 820, a waveguide cladding (e.g., upper cladding 112 in FIG. 1) is applied on the waveguide core. The waveguide cladding is made of a material that has a lower refractive index than a material of the waveguide core.

In step 830, a grating (e.g., a Bragg grating) is formed in the material of the waveguide cladding, after applying the waveguide cladding on the waveguide core, wherein the grating formed the waveguide cladding does not extend into the waveguide core.

In some embodiments, the waveguide cladding is etched to form the grating (e.g., shown in FIGS. 3A and 3B). In some embodiments, material is deposited on the waveguide cladding to form the grating (e.g., as discussed in the description of FIG. 2A).

In some embodiments, the waveguide core is formed in a device layer of a semiconductor structure. For example, the waveguide core is formed from a device layer of an SOI wafer. Electrical device can also be formed in the device layer of the semiconductor structure.

Embodiments were chosen and described in order to explain the principles of the invention and practical applications to thereby enable others skilled in the art to best utilize the invention in various embodiments and with various modifications as are suited to the particular use contemplated. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc.

A recitation of “a”, “an”, or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A system for waveguide structure comprising:
a waveguide core formed in a device layer of a semiconductor structure or a dielectric structure;
a waveguide cladding, wherein the waveguide cladding is made of a material that has a lower refractive index than a material of the waveguide core; and
a grating formed in the material of the waveguide cladding, wherein:
the grating formed in the waveguide cladding does not extend into the waveguide core;
the grating is a Bragg grating;
the Bragg grating has a periodic refractive index modulation between a high refractive index and a low refractive index;
the high refractive index is the material of the waveguide cladding; and
the waveguide structure is part of a photonic integrated chip.

2. The system of claim 1, wherein the waveguide core comprises lithium niobate, lithium tantalate, silicon, silicon nitride, or a III-V semiconductor compound.

3. A system for waveguide structure comprising:
a waveguide core;
a waveguide cladding, wherein the waveguide cladding is made of a material that has a lower refractive index than a material of the waveguide core; and
a grating formed in the material of the waveguide cladding, wherein the grating formed in the waveguide cladding does not extend into the waveguide core.

4. The system of claim 3, wherein the waveguide core is formed in a device layer of a semiconductor structure.

5. The system of claim 4, wherein the waveguide structure is part of a photonic integrated chip.

6. The system of claim 3, wherein the grating is a Bragg grating.

7. The system of claim 3, wherein:
the grating has a periodic refractive index modulation between a high refractive index and a low refractive index; and
the high refractive index is the material of the waveguide cladding.

8. The system of claim 3, wherein:
the waveguide core comprises single-crystal silicon or a III-V compound; and
the waveguide cladding comprises a silicon oxide.

9. The system of claim 3, wherein the waveguide core comprises lithium niobate, lithium tantalate, or silicon nitride.

10. The system of claim 3, wherein the waveguide core is a rib waveguide.

11. A method for making for a waveguide structure comprising:
forming a waveguide core;
applying a waveguide cladding on the waveguide core, wherein the waveguide cladding is made of a material that has a lower refractive index than a material of the waveguide core; and
forming a grating in the material of the waveguide cladding, after applying the waveguide cladding on the waveguide core, wherein the grating formed the waveguide cladding does not extend into the waveguide core.

12. The method of claim 11, further comprising etching the waveguide cladding to from the grating.

13. The method of claim 11, further comprising depositing material on the waveguide cladding to form the grating.

14. The method of claim 11, wherein the waveguide core is formed in a device layer of a semiconductor structure.

15. The method of claim 14, further comprising forming electrical devices in the device layer of the semiconductor structure.

16. The method of claim 14, wherein the waveguide structure is part of a photonic integrated chip.

17. The method of claim 14, wherein the grating is a Bragg grating.

18. The method of claim 14, wherein:
the grating has a periodic refractive index modulation between a high refractive index and a low refractive index; and
the high refractive index is the material of the waveguide cladding.

19. The method of claim 14, wherein:
the waveguide core comprises single-crystal silicon or a III-V compound; and
the waveguide cladding comprises a silicon oxide.

20. The method of claim 14, wherein the waveguide core comprises lithium niobate, lithium tantalate, or silicon nitride.
